(19) United States
(12) Patent Application Publication
(10) Pub. No.: US 2013/0277507 A1
(43) Pub. Date: Oct. 24, 2013

(54) HOSE HORN FOR FIBERGLASS INSTALLATION

(71) Applicant: FRANK STEVENS, Phillips, ME (US)

(72) Inventor: FRANK STEVENS, Phillips, ME (US)

(21) Appl. No.: 13/455,063

(22) Filed: Apr. 24, 2012

(51) Int. Cl. F16L 3/02

(52) U.S. Cl. 248/49

(57) ABSTRACT

A hose guidance device for guiding an insulation hose comprising: a body portion extending between a top edge and an attachment end, where the body portion includes a curved surface, which extends along the length of the body portion, wherein the body portion receives and guides the insulation hose into a wall cavity; and a handle extending from the attachment end of the body portion. The hose guidance device further includes a cord and a belt loop attached to the handle to attach the hose guidance device to a user's belt.

### BACKGROUND OF THE INVENTION

1. Field of Invention

The present invention relates to a device that assists in the installation of fiberglass insulation.

2. Description of Related Art

Building insulation materials provide thermal insulation for buildings by reducing heat transfer in the walls, roof or attic areas of a building. Building insulation is provided in many forms and includes the use of foam sprays, insulated panels, fiberglass batts and loose-fill particles that are blown into a wall cavity. In particular, loose-fill insulation involves the use of cellulose, fiberglass or rock wool as loose insulation materials that are blown into open cavities of a building. The use of the loose-fill insulation is well suited for difficult areas to install insulation that involve irregular shapes, obstructions and hard-to-reach places. The loose-fill insulation is typically blown through a hose and inserted through an opening to allow the insulation to accumulate in a particular area to fill the wall cavity opening as desired. The insulation hose is typically a pliable device that may need additional guidance in order to properly position the hose during the installation process. Consequently, it would therefore be advantageous to have a device that could assist in maneuvering an insulation hose into the wall cavity especially where insulation batts may previously exist within the cavity.

### SUMMARY OF THE INVENTION

In view of the foregoing disadvantages inherent in the prior art, the general purpose of the present invention is to provide an installation device for fiberglass, configured to include all of the advantages of the prior art, and to overcome the drawbacks inherent therein. Accordingly, an object of the present invention is to provide a hose guidance device to direct an insulation hose into a wall cavity.

Another object of the present invention is to provide a hose guidance device that includes a belt attachment the keep the device readily available while working.

To achieve the above objects, in an aspect of the present invention, a hose guidance device is described for guiding an insulation hose comprising: a body portion extending between a top edge and an attachment end, where the body portion includes a curved surface, which extends along the length of the body portion, wherein the body portion receives and guides the insulation hose into a wall cavity; and a handle extending from the attachment end of the body portion. The hose guidance device further includes a cord and a belt loop attached to the handle to attach the hose guidance device to a user's belt.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF DRAWINGS

The advantages and features of the present invention will become better understood with reference to the following detailed description and claims taken in conjunction with the accompanying drawings, wherein like elements are identified with like symbols, and in which:

FIG. 1 depicts a top view of an insulation hose-guiding device according to the present invention;

FIG. 2 depicts a front view of the insulation hose-guiding device according to the present invention;

FIG. 3 depicts a side view of the insulation hose-guiding device according to the present invention; and

FIG. 4 depicts a end view of the insulation hose-guiding device according to the present invention.

### DETAILED DESCRIPTION

The present invention relates to a hose guidance device that assists the user in guiding an insulation hose into a wall cavity. The hose guidance device according to the present invention includes a substantially curved device that includes an adequate width to support an insulation hose as being inserted through a wall cavity. The guidance device according to the present invention also includes a handle that extends from one side of the device and may further include a means to easily attach the other device to a user's belt for convenient retrieval and storage during a typical workday.

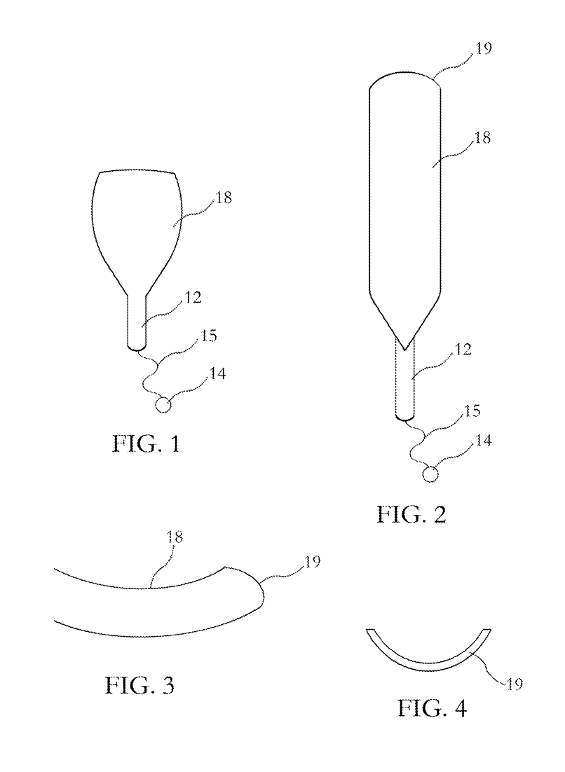

In reference to FIG. 1, a top view of a hose guidance device 18 according to the present invention is depicted. The top view depicts a handle 12 that extends from one side of the hose guidance device 18. The device 18 is essentially a curved surface, which extends along the length of the device 18 as shown in FIG. 2 to receive and guide an insulation hose into a wall cavity. In one particular embodiment, the hose guidance device 18 further includes a cord 15 and a belt loop 14 attached to the handle 12. The cord 15 and belt loop 14 provide a means to attach the hose guidance device 18 to a user's belt during use.

FIG. 2 depicts a front view of the hose guidance device 18 according to the present invention. As can be seen the hose guidance device 18 is somewhat rectangular but includes a curved surface along the length thereof from the top edge 19 to the attachment end where the handle 12 attaches. The smooth surface of the guidance device 18 provides an easy means to guide the insulation hose into a hose cavity during use. The device 18 helps the user to avoid contact with any obstructions within the wall cavity during the insertion of the hose. The use of the hose guidance device 18 according to the present invention alleviates many of the problems that may be associated with the feeding of the insulation hose into a wall cavity and helps to prevent damage to any existing insulation during the process.

FIG. 3 shows a side view of the hose guidance device 18 according to the present invention. FIG. 3 illustrates the hose guidance device 18 as a curved structure for easy insertion into the wall cavity. FIG. 4 shows an end view of the hose guidance device 18 at the top edge 19. As shown, the top edge 19 of the hose guidance device 18 comprises a semi-circular shape. The device may be manufactured with molded aluminum with a flexible curvature for adjustments to the wall cavity during use. The device may be further covered with a plastic so that the hose may smoothly move across the surface of the guidance device.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A hose guidance device for guiding an insulation hose comprising:
a. a body portion extending between a top edge and an attachment end, where the body portion includes a curved surface, which extends along the length of the body portion, wherein said body portion receives and guides the insulation hose into a wall cavity; and
b. a handle extending from the bottom end of the body portion.

2. The hose guidance device according to claim 1, further comprising a cord and a belt loop attached to the handle to attach the hose guidance device to a user's belt.

3. The hose guidance device according to claim 1, where the top end comprises a semi-circular shape.

4. The hose guidance device according to claim 1, where the hose guidance device is manufactured from a molded aluminum with a flexible curvature.

5. The hose guidance device according to claim 4, where the molded aluminum device is covered with a plastic so that the insulation hose moves smoothly along the surface of the body portion.
